(19) United States
(12) Patent Application Publication
(10) Pub. No.: US 2007/0113168 A1
(43) Pub. Date: May 17, 2007

(54) Visual representation and navigation of erroneous fields in a document

(75) Inventors: Claudio S. de Souza, Apex, NC (US); Richa Bansal, Cary, NC (US); Randy S. Haven, Raleigh, NC (US); William F. Trautman, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/281,331

(22) Filed: Nov. 17, 2005

(51) Int. Cl. G06F 17/00; G06F 3/00

(52) U.S. Cl. 715/507; 715/530; 715/764

(57) ABSTRACT

The present invention relates to the visual representation and navigation of erroneous fields in a document. A method in accordance with an embodiment of the present invention includes: detecting erroneous fields in a document; highlighting each erroneous field in the document; displaying an error message on the document, wherein the error message corresponds to one of the erroneous fields; displaying a first visual indicator adjacent the error message; and displaying a second visual indicator adjacent the erroneous field corresponding to the error message. Using the visual indicators, a user can locate the erroneous field in the document corresponding to the error message.

### BACKGROUND OF THE INVENTION

1. Field of the Invention

The present invention generally relates to user interfaces, and more specifically relates to the visual representation and navigation of erroneous fields in a document.

2. Related Art

When filling out fields in a form, wizard page, or other type of document on a computer, users often need to be notified about incorrect input. For example, as shown in FIG. 1, an error message 10 is often listed at the top of a document 12 and highlighted in some manner (e.g., using a colored icon 14 marked with an “X”). Although this strategy lets a user know that there is an error in the document 12, it does not point the user to the corresponding erroneous field 16. The user therefore needs to carefully read the error message 10 and then search the document 12 for the corresponding erroneous field 16 referred to by the error message 10. Further, in cases where there are multiple errors in the document 12, this strategy only lists one error at a time. Accordingly, an additional solution is needed to make the error notification process more user-responsive.

### SUMMARY OF THE INVENTION

The present invention relates to the visual representation and navigation of erroneous fields in a document. In particular, a visual indicator and an error message associated with an erroneous field are displayed at the top of a document. The same visual indicator is displayed adjacent (i.e., close to) the corresponding erroneous field in the document, thereby pointing the user to the corresponding erroneous field. This allows the user to quickly scan the error message and move to the corresponding erroneous field in the document for correction. Further, in order to inform the user of the presence of more than one erroneous field in a document, all erroneous fields are highlighted in the document (e.g., by changing the color of the field name of all erroneous fields). When the input of an erroneous field currently in focus is corrected, the error message at the top of the document changes to reflect the next erroneous field in top-down order, and the visual indicator is moved such that it is displayed adjacent the next erroneous field.

A first aspect of the present invention is directed to a method for representing and navigating erroneous fields in a document, comprising: detecting erroneous fields in the document; highlighting each erroneous field in the document; displaying an error message on the document, wherein the error message corresponds to one of the erroneous fields; displaying a first visual indicator adjacent the error message; and displaying a second visual indicator adjacent the erroneous field corresponding to the error message.

A second aspect of the present invention is directed to a system for representing and navigating erroneous fields in a document, comprising: a system for detecting erroneous fields in the document; a system for highlighting each erroneous field in the document; a system for displaying an error message on the document, wherein the error message corresponds to one of the erroneous fields; a system for displaying a first visual indicator adjacent the error message; and a system for displaying a second visual indicator adjacent the erroneous field corresponding to the error message.

A third aspect of the present invention is directed to a program product stored on a computer readable medium for representing and navigating erroneous fields in a document, the computer readable medium comprising program code for performing the steps of: detecting erroneous fields in the document; highlighting each erroneous field in the document; displaying an error message on the document, wherein the error message corresponds to one of the erroneous fields; displaying a first visual indicator adjacent the error message; and displaying a second visual indicator adjacent the erroneous field corresponding to the error message.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an error message displayed in a document in accordance with the prior art.

FIG. 2 depicts a flow diagram of a method in accordance with an embodiment of the present invention.

FIGS. 3-6 depict examples of the use of the present invention in a document.

FIG. 7 depicts an illustrative computer system for implementing embodiment(s) of the present invention.

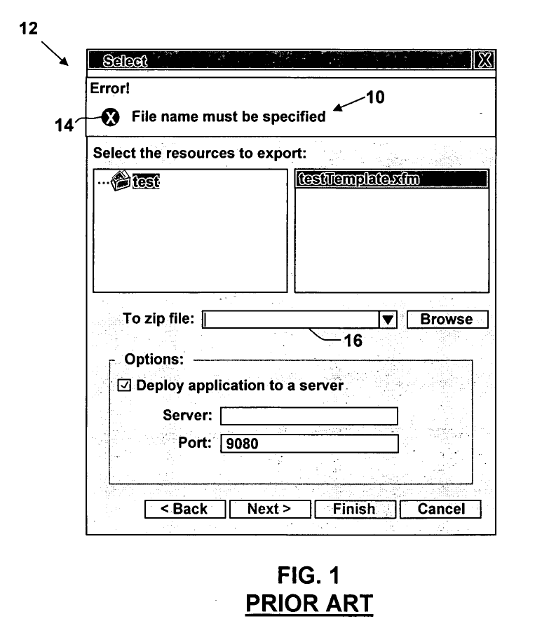

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention relates to the visual representation and navigation of erroneous fields in a document. In particular, a visual indicator and an error message associated with an erroneous field are displayed at the top of a document. The same visual indicator is displayed adjacent (i.e., close to) the corresponding erroneous field in the document, thereby pointing the user to the corresponding erroneous field. This allows the user to quickly scan the error message and move to the corresponding erroneous field in the document for correction. Further, in order to inform the user of the presence of more than one erroneous field in a document, all erroneous fields are highlighted in the document (e.g., by changing the color of the field name of all erroneous fields). When the input of an erroneous field currently in focus is corrected, the error message at the top of the document changes to reflect the next erroneous field in top-down order, and the visual indicator is moved such that it is displayed adjacent the next erroneous field.

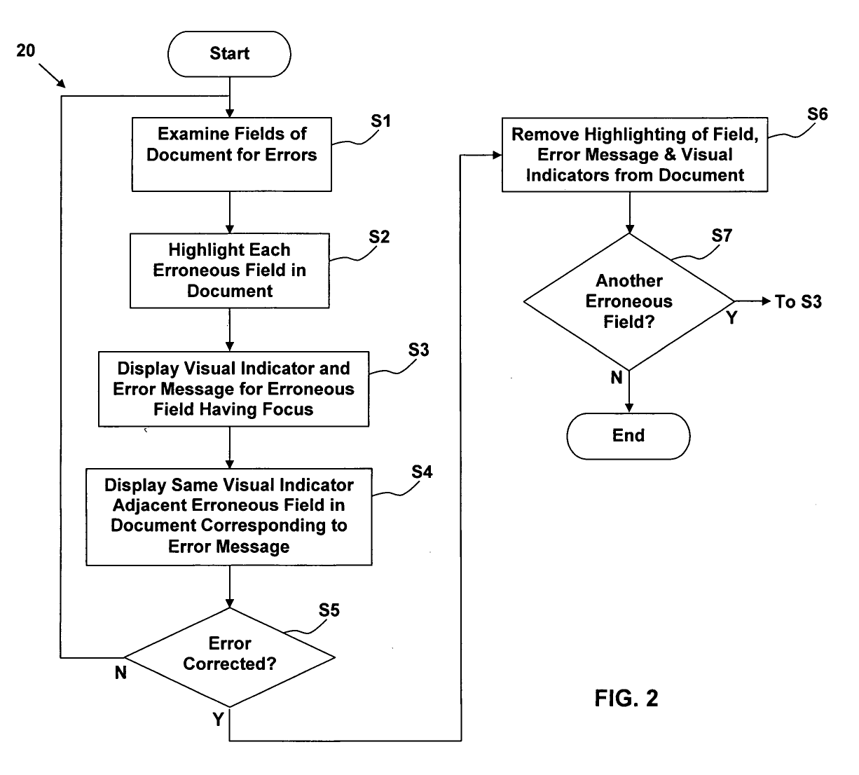

A flow diagram 20 of a method in accordance with an embodiment of the present invention is depicted in FIG. 2. In step S1, the fields within a document are examined for errors. Such errors can include, for example, an empty field where data is required, a field in which data has been input in an incorrect format, or a field containing an invalid entry. Many other types of errors, which are generally application/document specific, are also possible. Any suitable methodology for examining the fields within a document for errors can be used in the practice of the present invention.

In step S2, each field containing an error (i.e., each erroneous field) in the document is highlighted in some manner. For example, the label of an erroneous field can be displayed in a highly visible color (e.g., red or orange), using a larger-size font, using a different font, and/or using a distinctive font effect (bold, italics, etc.). Alternatively, or in addition, the background color of an erroneous field can be displayed in a color that is different than that used for fields that do not contain errors. Other now known or later developed highlighting techniques can also be used in the practice of the present invention. Advantageously, by highlighting each erroneous field in the document, a user can easily determine the number and location of all erroneous fields in the document that require correction.

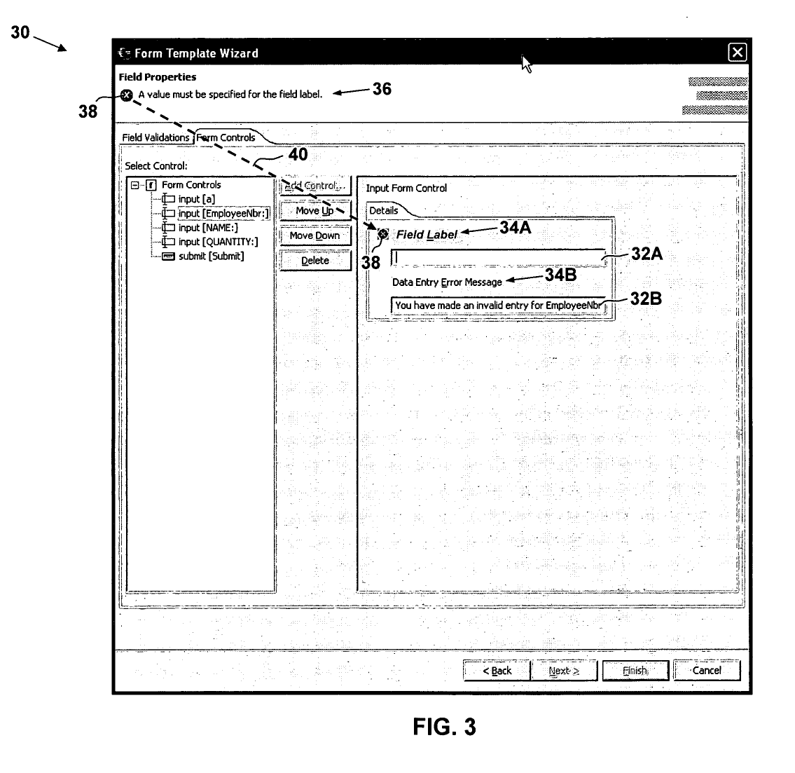

An example of the highlighting of an erroneous field is illustrated in FIG. 3. In particular, in the document 30 “Form Template Wizard,” the field 32A with the field label 34A “Field Label” is highlighted as being an erroneous field. In this case, the field label 34A “Field Label” is displayed using a bolded and italicized font having a bright red font color. Another field 32B in the document 30, with the field label 34B “Data Entry Error Message,” is not highlighted, indicating that that field does not contain an error.

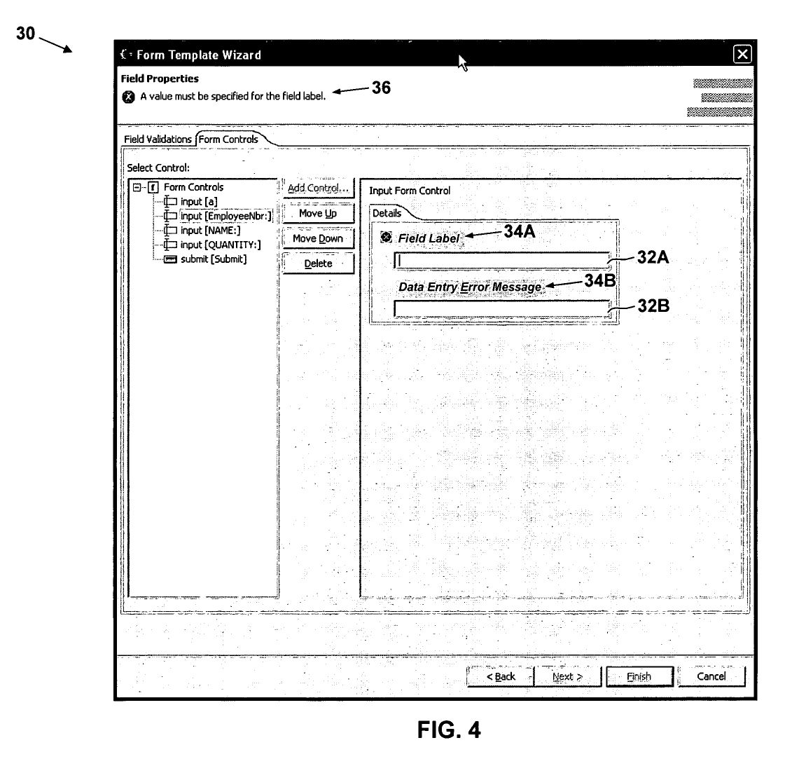

An example of the highlighting of multiple erroneous fields in a document is illustrated in FIG. 4. In this example, two fields in the document 30 “Form Template Wizard” contain errors and are highlighted as such using a bolded and italicized font having a bright red font color: the field 32A with the field label 34A “Field Label” and the field 32B with the field label 34B “Data Entry Error Message.” To this extent, a user examining the document 30 shown in FIG. 4 can easily determine based on the highlighting the number and location of all fields in the document 30 that require correction.

Returning to the flow diagram 20 depicted in FIG. 2, in step S3, an error message associated with an erroneous field is displayed at the top of the document along with a visual indicator. By default, the error message is associated with the top-most erroneous field in the document (i.e., the top-most erroneous field has focus). A plurality of different error messages can be provided and stored in a database or the like and selected as needed for display in the document. In step S4, the same visual indicator that is displayed adjacent the error message is displayed in the body of the document adjacent the erroneous field referenced by the error message. In general, the visual indicators can be identical or substantially similar to one another. As such, using the visual indicator as a guide, a user can easily determine which field in the document corresponds to the error message displayed at the top of the document. If it is determined in step S5 that the field has been corrected by the user, then in step S6, the highlighting of the corrected field, the error message, and the visual indicators are removed from the document. If it is determined in step S7 that another erroneous field in present in the document, then flow passes back to step S3, where the process is repeated for the top-most remaining erroneous field in the document. It should be noted that if the user shifts focus to a different erroneous field at any time (e.g., by clicking on the field), then the above-described process is performed for that selected field. Once the user-selected erroneous field has been corrected, then flow passes back to step S3, where the process is repeated for the top-most erroneous field in the document.

A first example of the use of a visual indicator in accordance with the present invention is illustrated in FIG. 3. As shown, an error message 36 (“A value must be specified for the field label”) is displayed at the top of the document 30 and a visual indicator 38 is displayed adjacent the error message 36. In this example, the visual indicator 38 comprises a colored icon marked with an “X,” although almost any type of visual indicator 38 can be used in the practice of the present invention. The same visual indicator 38 is also displayed adjacent the field 32A with the field label 34A “Field Label” in the document 30. This indicates that the field 32A with the field label 34A “Field Label” contains the error described in the error message 36. By using the same visual indicator 38, a user can easily determine (as indicated by the phantom arrow 40) that the field 32A with the field label 34A “Field Label” corresponds to the displayed error message 36 and requires corrective action.

Another example of the use of a visual indicator in accordance with the present invention is illustrated in FIG. 4. In this example, as detailed above, multiple erroneous fields are present in the document 30. By default, working top-down through the document 30, the error message 36 displayed at the top of the document 30 is associated with the top-most erroneous field, namely the field 32A with the field label 34A “Field Label.” In addition, the same visual indicator 38 is displayed adjacent the error message 36 and adjacent the field 32A with the field label 34A “Field Label.”

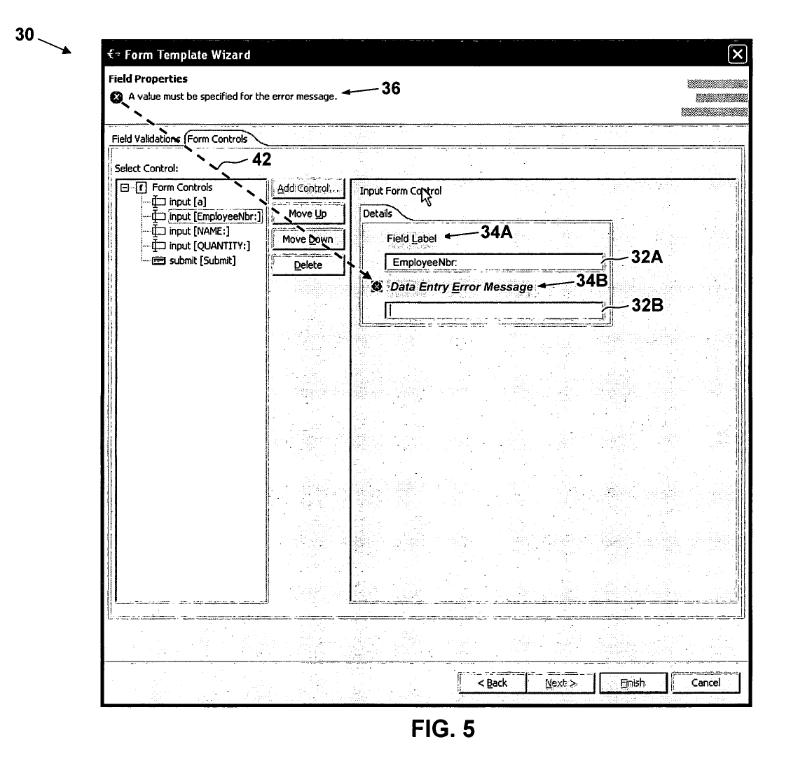

After a user corrects the data in the field 32A with the field label 34A “Field Label,” the document 30 appears as shown in FIG. 5. In particular, comparing FIGS. 4 and 5, it can be seen that the field label 34A “Field Label,” is no longer highlighted. In addition, it can be seen that the error message 36 (“A value must be specified for the field label”) and the visual indicator 38 adjacent the field 32A with the field label 34A “Field Label” have disappeared. Instead, a new error message 36 is displayed (“A value must be displayed for the error message”) with respect to the next erroneous field (top-down) in the document 30. In addition, the same visual indicator 38 is displayed adjacent the error message 36 and adjacent the field 32B with the field label 34B “Data Entry Error Message.” By using the same visual indicator 38, a user can easily determine (as indicated by the phantom arrow 42) that the field 32B with the field label 34B “Data Entry Error Message.” corresponds to the displayed error message 36 and requires corrective action.

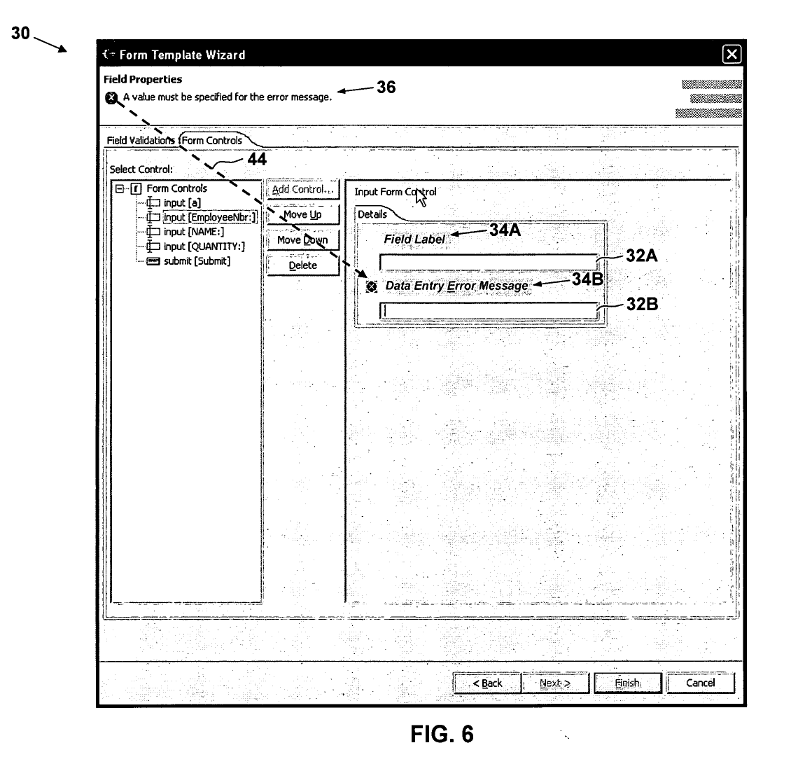

If the user chooses not to correct the data in the field 32A with the field label 34A “Field Label,” (FIG. 4), but instead clicks on the field 32B with the field label 34B “Data Entry Error Message,” the document 30 appears as shown in FIG. 6. In this case, the field 32B with the field label 34B “Data Entry Error Message” now has focus, rather than the field 32A with the field label 34A “Field Label.” However, because it has not yet been corrected, the field 32A with the field label 34A “Field Label” remains highlighted. The error message 36 (“A value must be displayed for the error message”) displayed at the tope of the document is associated with the field 32B with the field label 34B “Data Entry Error Message” (i.e., the field now in focus). In addition, as indicated by the phantom arrow 44, the same visual indicator 38 is displayed adjacent the error message 36 and adjacent the field 32B with the field label 34B “Data Entry Error Message.”

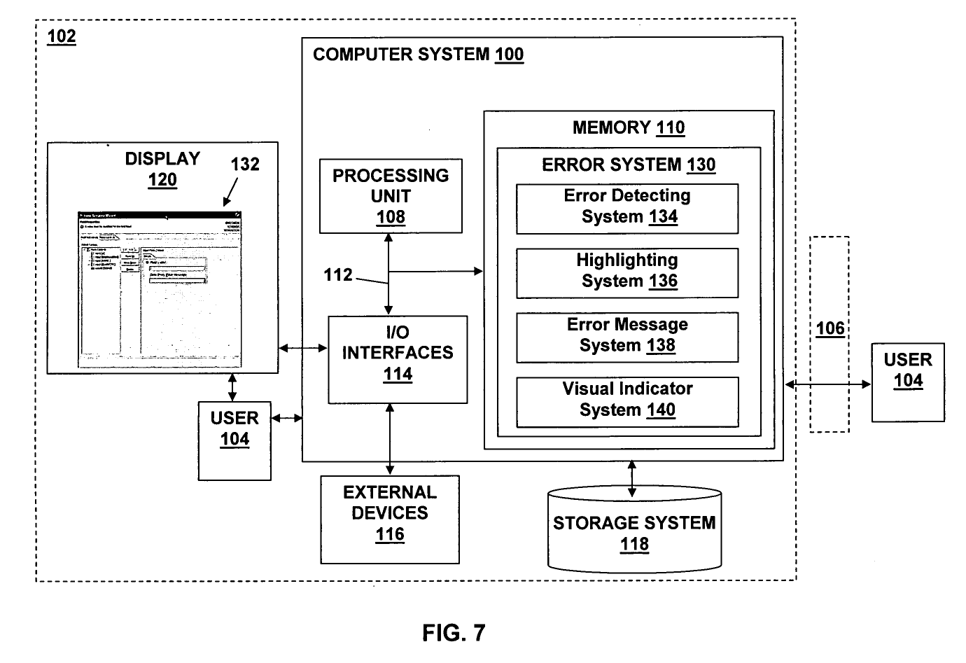

A computer system 100 for the visual representation and navigation of erroneous fields in a document in accordance with an embodiment of the present invention is depicted in FIG. 7. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides for the visual representation and navigation of erroneous fields in a document in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet. Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as error system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 7 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an error system 130 for the visual representation and navigation of erroneous fields in a document 132 in accordance with embodiments of the present invention. The error system 130 includes an error detecting system 134 for detecting erroneous fields in the document 132, a highlighting system 136 for highlighting all erroneous fields in the document 132, and an error message system 138 for determining which erroneous field is currently in focus and for displaying an error message on (e.g., at the top of) the document 132 that is associated with the erroneous field currently in focus. The error system 130 further includes a visual indicator system 140 for displaying a visual indicator adjacent the error message and adjacent the erroneous field currently in focus.

The present invention can be offered as a business method on a subscription or fee basis. For example, one or more components of the present invention can be created, maintained, supported, and/or deployed by a service provider that offers the functions described herein for customers. That is, a service provider can be used to provide for the visual representation and navigation of erroneous fields in a document, as described above.

It should also be understood that the present invention can be realized in hardware, software, or a combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for representing and navigating erroneous fields in a document, comprising:
detecting erroneous fields in the document;
highlighting each erroneous field in the document;
displaying an error message on the document, wherein the error message corresponds to one of the erroneous fields;
displaying a first visual indicator adjacent the error message; and
displaying a second visual indicator adjacent the erroneous field corresponding to the error message.

2. The method of claim 1, further comprising:
determining which erroneous field in the document is currently in focus, wherein the error message displayed on the document corresponds to the erroneous field currently in focus.

3. The method of claim 2, wherein a top-most erroneous field in the document is currently in focus.

4. The method of claim 2, wherein an erroneous field selected by a user is currently in focus.

5. The method of claim 1, wherein highlighting each erroneous field in the document further comprises:
highlighting a field label of each erroneous field in the document.

6. The method of claim 1, wherein the first visual indicator and the second visual indicator are substantially similar to each other.

7. A system for representing and navigating erroneous fields in a document, comprising:
a system for detecting erroneous fields in the document;
a system for highlighting each erroneous field in the document;
a system for displaying an error message on the document, wherein the error message corresponds to one of the erroneous fields;
a system for displaying a first visual indicator adjacent the error message; and
a system for displaying a second visual indicator adjacent the erroneous field corresponding to the error message.

8. The system of claim 7, further comprising:
a system for determining which erroneous field in the document is currently in focus, wherein the error message displayed on the document corresponds to the erroneous field currently in focus.

9. The system of claim 8, wherein a top-most erroneous field in the document is currently in focus.

10. The system of claim 8, wherein an erroneous field selected by a user is currently in focus.

11. The system of claim 7, wherein highlighting each erroneous field in the document further comprises:
highlighting a field label of each erroneous field in the document.

12. The system of claim 7, wherein the first visual indicator and the second visual indicator are substantially similar to each other.

13. A program product stored on a computer readable medium for representing and navigating erroneous fields in a document, the computer readable medium comprising program code for performing the steps of:
detecting erroneous fields in the document;
highlighting each erroneous field in the document;
displaying an error message on the document, wherein the error message corresponds to one of the erroneous fields;
displaying a first visual indicator adjacent the error message; and
displaying a second visual indicator adjacent the erroneous field corresponding to the error message.

14. The program product of claim 13, further comprising program code for performing the step of:
determining which erroneous field in the document is currently in focus, wherein the error message displayed on the document corresponds to the erroneous field currently in focus.

15. The program product of claim 14, wherein a top-most erroneous field in the document is currently in focus.

16. The program product of claim 14, wherein an erroneous field selected by a user is currently in focus.

17. The program product of claim 13, wherein the program code for performing the step of highlighting each erroneous field in the document further comprises program code for performing the step of:
highlighting a field label of each erroneous field in the document.

18. The program product of claim 13, wherein the first visual indicator and the second visual indicator are substantially similar to each other.
